(19) United States
(12) Patent Application Publication
(10) Pub. No.: US 2024/0402508 A1
(43) Pub. Date: Dec. 5, 2024

(54) APPARATUS AND METHOD FOR COMBINING COHERENT LASER BEAMS, AND LASER SYSTEM

(71) Applicant: TRUMPF Laser GmbH, Schramberg (DE)

(72) Inventors: Malte Kumkar, Weimar (DE); Aleksander Budnicki, Waldkirch (DE); Daniel Grossmann, Schramberg (DE)

(21) Appl. No.: 18/800,175

(22) Filed: Aug. 12, 2024

Related U.S. Application Data
(63) Continuation of application No. PCT/EP2023/053071, filed on Feb. 8, 2023.

(30) Foreign Application Priority Data
Feb. 14, 2022 (DE) 10 2022 103 418.6

(51) Int. Cl. G02B 27/10; H01S 3/10

(52) U.S. Cl. CPC G02B 27/1093; H01S 3/10053

(57) ABSTRACT

An apparatus for combining coherent laser beams to form at least one combined laser beam includes a phase setting device, and a gain device for amplifying the coherent laser beams to form amplified coherent laser beams. The amplified coherent laser beams are output coupled from the gain device. The apparatus further includes a control device for controlling the phase setting device based on a specified assignment rule in order to set a respective phase difference between the amplified coherent laser beams to specified target phase difference values, a measuring device for determining a respective actual phase difference value between the amplified coherent laser beams, and an optimization unit coupled to the control device and configured to optimize the assignment rule based on the actual phase difference values determined by the measuring device.

### CROSS REFERENCE TO RELATED APPLICATIONS

This application is a continuation of International Application No. PCT/EP2023/053071 (WO 2023/152161 A1), filed on Feb. 8, 2023, and claims benefit to German Patent Application No. DE 10 2022 103 418.6, filed on Feb. 14, 2022. The aforementioned applications are hereby incorporated by reference herein.

### FIELD

Embodiments of the present invention relate to an apparatus and a method for combining coherent laser beams to form at least one combined laser beam, and to a laser system.

### BACKGROUND

DE 10 2020 201 161 A1 has disclosed an apparatus for combining a plurality of coherent laser beams, comprising a splitting device for splitting an input laser beam into the plurality of coherent laser beams, a plurality of phase setting devices for setting a respective phase of one of the coherent laser beams, and a beam combination device for combining the coherent laser beams, which emanate from a plurality of grid positions of a grid arrangement, to form at least one combined laser beam, with the beam combination device having a microlens arrangement with exactly one microlens array for forming the at least one combined laser beam.

U.S. Pat. No. 9,134,538 B1 has disclosed a system for coherently combining a multiplicity of optical beams, comprising a resonance cavity, a multiplicity of gain elements arranged within the resonance cavity, a beam-combining element which is in optical communication with the gain elements and serves to coherently combine the optical beams to form a coherent output beam, a sensor which is in optical communication with the beam combining element and serves to capture at least one portion of the coherent output beam and provide a feedback signal representative for the at least one portion of the coherent output beam, and a phase controller which is coupled to the sensor and serves to set a phase of at least one of the optical beams on the basis of the feedback signal.

WO 2017/125345 A1 has disclosed a phase control system for controlling the relative phase of two laser beams of a laser system to be coherently combined, permitting the provision of a phase-controlled sum laser beam.

### SUMMARY

Embodiments of the present invention provide an apparatus for combining coherent laser beams to form at least one combined laser beam. The apparatus includes a phase setting device, and a gain device for amplifying the coherent laser beams to form amplified coherent laser beams. The amplified coherent laser beams are output coupled from the gain device. The apparatus further includes a control device for controlling the phase setting device based on a specified assignment rule in order to set a respective phase difference between the amplified coherent laser beams to specified target phase difference values, a measuring device for determining a respective actual phase difference value between the amplified coherent laser beams, and an optimization unit coupled to the control device and configured to optimize the assignment rule based on the actual phase difference values determined by the measuring device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an apparatus for combining a plurality of coherent laser beams according to some embodiments;

FIG. 2a shows a combination element which is embodied as a diffractive optical element and serves to combine amplified coherent laser beams to form a combined laser beam, according to some embodiments;

FIG. 2b shows a combination element which is embodied as a microlens array and serves to combine amplified coherent laser beams to form a combined laser beam, according to some embodiments;

FIG. 2c shows a lens element for focusing amplified coherent laser beams according to some embodiments;

FIG. 3 shows a schematic illustration of an output coupling device for partial output coupling of amplified coherent laser beams, in order to supply these to a measuring device, according to some embodiments;

FIG. 4 shows a schematic illustration of measuring units of the measuring device, with the measuring units each being used to measure a phase difference between pairs of mutually adjacent amplified coherent laser beams, according to some embodiments;

FIG. 5 shows a schematic illustration of measuring units of the measuring device, with the measuring units each being used to measure a phase difference between pairs of the same first and a further one of the amplified coherent laser beams, according to some embodiments;

FIG. 6 shows a schematic illustration of a further configuration of measuring units in the measuring device according to some embodiments;

FIG. 7a shows a schematic illustration of an exemplary embodiment of a measuring unit, the measuring unit having three measuring paths with one measuring element each, according to some embodiments;

FIGS. 7b, 7c and 7d show schematic illustrations of laser pulses of the amplified coherent laser beams, which are each incident on the different measuring elements of the measuring unit according to FIG. 7a, with pairs of laser pulses being incident on the respective measuring elements with a different time offset in each case, according to some embodiments;

FIG. 8 shows a schematic illustration of an intensity profile, measured by means of a measuring element, as a function of a phase difference of respective laser pulses of two different amplified coherent laser beams, according to some embodiments;

FIG. 9a shows a schematic illustration of an exemplary embodiment of a measuring unit which comprises a single measuring element, according to some embodiments;

FIG. 9b shows a schematic illustration of laser pulses of the amplified coherent laser beams, with pairs of laser pulses being incident on the measuring element with a different time offset in each case and with different pairs being incident on the measuring element with a time offset, according to some embodiments;

FIG. 10 shows a schematic illustration of a further exemplary embodiment of a measuring unit which comprises a single measuring element, according to some embodiments;

FIG. 11 shows a schematic illustration of an exemplary embodiment of a measuring unit with one measuring element, with retardation elements being provided in order to create an offset phase difference of more than 2*pi, according to some embodiments;

FIG. 12a shows an example of a time curve of set target phase difference values between two amplified coherent laser beams, according to some embodiments;

FIG. 12b shows an example of a temporal succession of measurements performed by means of a measuring device for the purpose of measuring actual phase difference values between the amplified coherent laser beams, according to some embodiments;

FIG. 12c shows an example of a time curve of a deviation between target phase difference values and actual phase difference values, according to some embodiments; and

FIG. 12d shows an example of a temporal sequence of an optimization of an assignment rule, on the basis of which the target phase difference values are set, according to some embodiments.

### DETAILED DESCRIPTION

Embodiments of the present invention provide an apparatus and a method to realize increased reliability of combining coherent laser beams with high temporal and/or spatial dynamics.

According to embodiments of the invention, the apparatus comprises a phase setting device for setting a respective phase difference between the coherent laser beams, a gain device for amplifying the coherent laser beams, with amplified coherent laser beams being output coupled from the gain device, a control device for controlling the phase setting device on the basis of a specified assignment rule in order to set the respective phase difference between the amplified coherent laser beams to specified target phase difference values, a measuring device for determining the respective phase difference between the amplified coherent laser beams, with actual phase difference values between the amplified coherent laser beams being determined by means of the measuring device, and an optimization unit assigned to the control device and serving to optimize the assignment rule on the basis of the actual phase difference values determined by means of the measuring device.

Deviations between the target phase difference values set on the basis of the assignment rule and the actually present actual phase difference values may arise during the operation of the apparatus. The cause of this can be traced back to, for example, a heating of components in the apparatus, for instance of the phase setting device and/or the gain device. This heating may influence the actual phase difference between the amplified coherent laser beams.

Thus, according to embodiments of the invention, the assignment rule is optimized during the operation of the apparatus on the basis of the actual phase difference values determined by means of the measuring device. This allows minimization of deviations between the target phase difference values to be set and the actually present actual phase difference values. A reliable operation of the apparatus can be ensured as a result.

In particular, provision can be made for a laser processing procedure to be performed on a workpiece by means of the at least one combined laser beam when the apparatus is in operation. In particular, the assignment rule is optimized during the laser processing procedure on a workpiece when the apparatus is in operation, or it is optimizable during the laser processing procedure on a workpiece.

In particular, provision can be made for the assignment rule to be updated at time intervals by means of the optimization unit. In particular, the assignment rule is updated at regular time intervals. However, in principle it is also possible for updating to be implemented at irregular or random time intervals.

Updating the assignment rule at time intervals should be understood to mean that the assignment rule can be fundamentally modified or is fundamentally modifiable by the optimization unit at these time intervals. This does not require the assignment rule to in fact be modified in terms of content at each update. In principle, it is possible that the assignment rule remains the same in terms of content at one or more updates.

The aforementioned updating of the assignment rule makes it possible to ensure a minimized deviation between target phase difference values and actual phase difference values while the apparatus is in operation.

In particular, provision can be made for the assignment rule to be modified and/or adapted by means of the optimization unit such that a deviation between target phase difference values set by means of the control device according to the assignment rule and actual phase difference values measured by means of the measuring device is minimized. In this case, the assignment rule need not necessarily be modified in full; instead, it may also for instance be modified in part and/or in sections.

It may be advantageous if control of the phase setting device by means of the control device is implemented with a phase setting frequency, and if the assignment rule is updated with an optimization frequency. In that case, provision can be made in particular for the phase setting frequency to be greater than the optimization frequency.

In particular, the phase setting frequency should be understood to mean a frequency or a time interval arising from the frequency, at which the phase setting device can be or is controlled by the control device when the apparatus is in operation.

In particular, the optimization frequency should be understood to mean a frequency or a time interval arising from the frequency, at which the assignment rule can be or is updated when the apparatus is in operation.

The phase setting frequency and/or the optimization frequency are not necessarily constant during the operation of the apparatus; instead, they may vary during operation. In particular, the phase setting frequency or the optimization frequency should be understood to mean a current phase setting frequency or optimization frequency when the apparatus is in operation.

In particular, the phase setting frequency or a current phase setting frequency is at least 1 MHz and/or at most 1 GHz and preferably at least 10 MHz and/or at most 50 MHz when the apparatus is in operation. This allows the coherent laser beams to be combined with a high different combined laser beams. For example, this allows a quick variation of beam distributions and/or pulse parameters, and this for example in turn allows processing of workpieces with an increased speed and with an increased temporal and/or spatial resolution.

In particular, the optimization frequency or a current optimization frequency is at least 0.5 kHz and/or at most 5 kHz and preferably at least 2 kHz and/or at most 5 kHz when the apparatus is in operation.

As a result of the optimization frequency being lower than the phase setting frequency, the phase differences between the amplified coherent laser beams can be set significantly faster than an assignment rule update. This results in a reduction in a data transfer rate and/or computational performance required for optimizing the assignment rule while at the same time allowing phase differences to be set very quickly.

For the same reason, it may be advantageous for the actual phase difference values between the amplified coherent laser beams to be determined by means of the measuring device with a measuring interval frequency, with the phase setting frequency being greater than the measuring interval frequency.

In particular, the measuring interval frequency is at least 0.5 kHz and/or at most 5 kHz.

For example, the measuring interval frequency corresponds at least approximately to the optimization frequency.

It may be expedient for the actual phase difference values between the amplified coherent laser beams to be determined by means of the measuring device with a measuring accuracy frequency which is greater than or equal to the phase setting frequency. A sufficiently accurate measurement of the respective phase differences can be ensured as a result.

In principle, it is also possible for the measuring accuracy frequency to be smaller than the phase setting frequency by a factor of no more than 5.

The measuring accuracy frequency is not necessarily constant during the operation of the apparatus; instead, it may vary during operation. In particular, the measuring accuracy frequency should be understood to mean a current measuring accuracy frequency when the apparatus is in operation.

In particular, the measuring accuracy frequency is at least 1 MHz and/or at most 50 MHz.

In particular, provision can be made for the assignment rule to comprise an assignment of control values used by the control device to control the phase setting device to target phase difference values of the respective amplified coherent laser beams, and/or for the assignment rule to be or comprise an assignment table.

In principle, it is also possible for the assignment rule to be or comprise a mathematical function.

In particular, the control device is assigned a memory device in which the assignment rule is stored. For example, the control device comprises the memory device.

In an embodiment, the apparatus comprises at least one additional measuring device for determining the respective phase difference between the amplified coherent laser beams, with actual phase difference values between the amplified coherent laser beams being determined by means of the at least one additional measuring device. In particular, the at least one additional measuring device is arranged downstream of the measuring device. In particular, the at least one additional measuring device can be used to capture additional measurement values for the actual phase difference values, as a result of which the respective phase difference can be ascertained with increased accuracy. For example, the additional measuring device can be used to at least partially compensate for deviations of the target phase difference values which may result from the measurement by means of the measuring device. In particular, this yields an improved optimization of the assignment rule and/or a reduced deviation between target and actual phase difference values.

In particular, the at least one additional measuring device allows additional measurements to be performed at a measuring position in the beam path that differs from a measuring position of the measuring device. For instance, the measuring position of the additional measuring device may be located in a region of a workpiece which is processed by means of the at least one combined laser beam. As a result, the target phase difference values or actual phase difference values can be set or measured in a targeted fashion at a position relevant to the application of the apparatus.

Provision can also be made for calibration measurements to be performed by means of the at least one additional measuring device, in order to define a start version of the assignment rule.

In the present case, a first device and/or a first element of the apparatus being arranged downstream of a second device and/or a second element of the apparatus in the main propagation direction should be understood to mean that the coherent laser beams or amplified coherent laser beams initially strike the second device and/or the second element and subsequently strike the first device and/or the first element. Then, the second device and/or the second element is arranged upstream of the first device and/or the first element.

A measuring accuracy frequency and/or a measuring interval frequency of the at least one additional measuring device may at least approximately correspond to a measuring accuracy frequency or a measuring interval frequency of the measuring device as a matter of principle.

In particular, provision can be made for a measuring accuracy frequency and/or a measuring interval frequency of the at least one additional measuring device to be less than a measuring accuracy frequency or measuring interval frequency of the measuring device. For example, the measuring accuracy frequency of the at least one additional measuring device is at least 0.5 kHz and/or at most 500 kHz.

In an embodiment, the apparatus comprises at least one sensor element for measuring a parameter that influences the respective phase difference between the amplified coherent laser beams, with measurement values determined by means of the at least one sensor element being transmitted to the control device and/or to the optimization unit.

In particular, provision can then be made for the measurement values determined by means of the at least one sensor element to be used for optimizing the assignment rule. In particular, this yields an improved optimization of the assignment rule and/or a reduced deviation between target and actual phase difference values.

In particular, the measuring device and the at least one additional measuring device are used to determine the actual phase difference values between all amplified coherent laser beams present and/or, in pairwise fashion, between all amplified coherent laser beams present. In particular, the measuring device is used to determine the actual phase difference values for all possible combinations of the amplified coherent laser beams present.

In particular, provision is made for a respective phase difference between the amplified coherent laser beams prior to their combination and at least one combined laser beam to be measured by means of the measuring device and the at least one additional measuring device.

For example, the measuring device comprises a plurality of measuring units, with one of the amplified coherent laser beams and a further one of the amplified coherent laser beams being input coupled into a respective measuring unit.

A measuring unit in the measuring device comprises at least one measuring element for measuring the intensity of a spatial superposition of the two amplified coherent laser beams. For example, the measuring element is designed as a photodetector or comprises a photodetector. For example, the photodetector can be a fast photodetector and/or a clocked photodetector and/or a photodiode.

The coherent laser beams can be pulsed laser beams or continuous wave laser beams. In particular, the coherent laser beams are ultrashort pulse laser beams.

In particular, the apparatus is configured to combine the amplified coherent laser beams to form the at least one coherent laser beam. In particular, the coherent laser beams and/or the amplified coherent laser beams in each case are laser beams serving the purpose of being combined to form the at least one combined laser beam.

For example, the gain device may comprise a fiber amplifier, slab amplifier, rod amplifier or disk amplifier.

Provision can be made for the gain device to comprise a frequency conversion stage or for the gain device to be assigned a frequency conversion stage of the apparatus.

In particular, a respective phase difference between the coherent laser beams and/or between the amplified coherent laser beams is settable by means of the phase setting device.

In particular, a change in the phase difference between the coherent laser beams performed by means of the phase setting device brings about a change in the phase difference between the corresponding amplified coherent laser beams.

In an embodiment, the apparatus comprises a combination device for combining the amplified coherent laser beams to form the at least one combined laser beam. For example, the combination device comprises at least one microlens array and/or at least one diffractive optical element and/or at least one interferometer optics system and/or at least one polarization-influencing element.

For example, the combination device comprises at least one diffractive optical element, with the at least one diffractive optical element comprising a grating structure with a periodic pattern, for example. For example, this allows realization of a combination of the coherent laser beams according to the “filled aperture” principle.

Provision can be made for the combination device to comprise at least one microlens array for combining the coherent laser beams. For example, this allows realization of a combination of the coherent laser beams according to the “mixed aperture” principle.

In principle, it is also possible for the amplified coherent laser beams to be combined to form the at least one combined laser beam without a combination device. For example, the amplified coherent laser beams are then combined by propagation in the far field to form the at least one combined laser beam (“tiled aperture” principle).

For example, at least one lens element can be provided for projecting the amplified coherent laser beams into at least one combined laser beam. For example, this allows realization of a combination of the coherent laser beams according to the “tiled aperture” principle.

Provision can be made for the combination device to comprise a frequency conversion stage or for the combination device to be assigned a frequency conversion stage of the apparatus. In particular, the frequency conversion stage is disposed upstream of the combination device. In particular, provision can be made for the apparatus to comprise at least one laser source for providing the coherent laser beams.

According to embodiments of the invention, the laser system as mentioned at the outset comprises at least one laser source for providing coherent laser beams and an above-described apparatus for combining the coherent laser beams.

In particular, one or more laser sources may be provided for the provision of the coherent laser beams. In the case of a single laser source, a plurality of coherent laser beams are created by splitting an input laser beam provided by means of this laser source. In the case of a plurality of laser sources, at least one coherent laser beam is provided by means of each of the laser sources.

According to embodiments of the invention, the method for combining coherent laser beams, as a mentioned at the outset, provides for a respective phase difference between the coherent laser beams to be set by means of a phase setting device, for the coherent laser beams to be amplified by means of a gain device, with amplified coherent laser beams being output coupled from the gain device, for the phase setting device to be controlled by means of a control device on the basis of a specified assignment rule in order to set a respective phase difference between the amplified coherent laser beams to specified target phase difference values, for the respective phase difference between the amplified coherent laser beams to be determined by means of a measuring device, with actual phase difference values between the amplified coherent laser beams being determined by means of the measuring device, and for the assignment rule to be optimized on the basis of the actual phase difference values determined by means of the measuring device by means of an optimization unit assigned to the control device.

In particular, provision can be made for target phase difference values to be specified and for the control device to control the phase setting device with control values according to the assignment rule in order to set the respective phase difference between the amplified coherent laser beams to the specified target phase difference values.

In particular, in order to optimize the assignment rule by means of the control device, provision can be made for target phase difference values set according to the assignment rule to be compared with actual phase difference values measured by means of the measuring device. In particular, the assignment rule is modified and/or adapted in such a way in that case that a difference between the target phase difference values and actual phase difference values is minimized.

In particular, the specifications “at least approximately” or “approximately” should be understood to mean in general a deviation of at most 10%. Unless stated otherwise, the specifications “at least approximately” or “approximately” are to be understood to mean in particular that an actual value and/or distance and/or angle deviates by no more than 10% from an ideal value and/or distance and/or angle.

Elements which are the same or have equivalent functions are provided with the same reference signs in all of the figures.

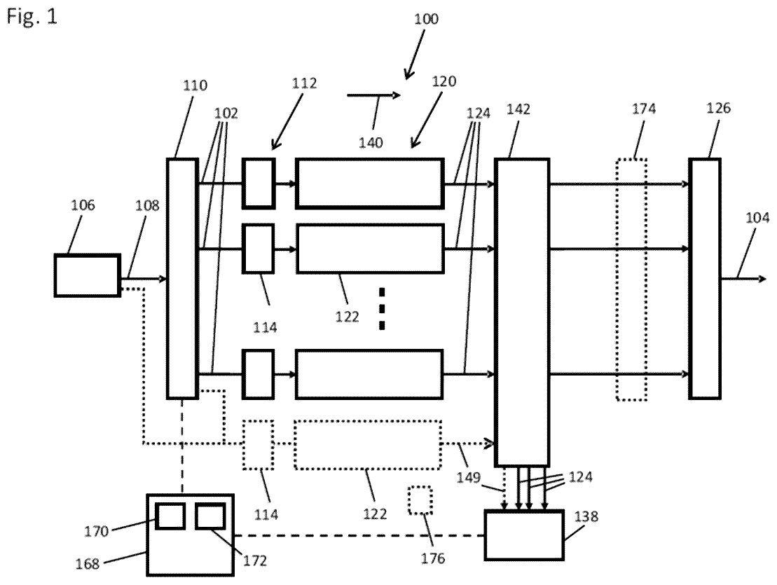

One exemplary embodiment of an apparatus for combining coherent laser beams is shown schematically in FIG. 1 and denoted by 100 therein. The apparatus 100 can be used to combine the coherent laser beams 102 (coherent beam combining), wherein one or more combined laser beams 104 are formed.

In the exemplary embodiment according to FIG. 1, provision is made for an input laser beam 108 to be provided by means of a laser source 106 and for a plurality of coherent laser beams 102 to be formed by splitting the input laser beam 108.

Alternatively, a plurality of laser sources 106 may also be provided for the provision of the coherent laser beams 102. For example, one or more coherent laser beams 102 are then provided by means of a respective laser source 106.

A splitting device 110 is provided for splitting the input laser beam 108 into a plurality of coherent laser beams 102. For example, FIG. 1 shows three coherent laser beams 102, which are formed by splitting the input laser beam 108 by means of the splitting device 110.

The input laser beam 108 and/or the coherent laser beams 102 are pulsed laser beams by way of example and ultrashort pulse laser beams in particular.

In particular, the coherent laser beams 102 have the same properties, for example the same wavelength and/or the same spectrum.

A phase setting device 112 is provided for setting a respective phase difference between the individual coherent laser beams 102. In particular, the phase setting device 112 comprises a plurality of phase setting elements 114, with a phase of an assigned coherent laser beam 102 being settable by means of a specific phase setting element 114. For example, a plurality or all of the coherent laser beams 102 are assigned a respective phase setting element 114.

In the case of N coherent laser beams 102, the phase setting device 112 comprises for example N-1 or N phase setting elements 114.

In respect of the technical details regarding the combination of coherent laser beam, reference is made to the following scientific publications: “Coherent combination of ultrafast fiber amplifiers”, Hanna, et al., Journal of Physics B: Atomic, Molecular and Optical Physics 49(6) (2016), 062004; “Performance scaling of laser amplifiers via coherent combination of ultrashort pulses”, Klenke, Mensch und Buch Verlag; “Coherent beam combining with an ultrafast multicore Yb-doped fiber amplifier”, Ramirez, et al., Optics Express 23(5), (2015), 5406-5416; and “Highly scalable femtosecond coherent beam combining demonstrated with 19 fibers”, Le Dortz, et al., Optics Letters 42(10), (2017), 1887-1890.

The apparatus 100 comprises a gain device 120 for amplifying the coherent laser beams 102. In particular, the gain device 120 comprises a plurality of gain elements 122, with for example a respective one of the coherent laser beams 102 being assigned one gain element 122.

In the example shown in FIG. 1, the coherent laser beams 102 are input coupled into the gain device 120 or into the respective gain elements 122 of the gain device 120. In particular, the respective phase differences between the coherent laser beams 102 are set by means of the phase setting device 112 before the coherent laser beams 102 are input coupled into the gain device 120.

The coherent laser beams 102 which were amplified by means of the gain device 120 are referred to hereinbelow as amplified coherent laser beams 124. In the example shown, the number of coherent laser beams 102 present corresponds to the number of amplified coherent laser beams 124 present.

To combine the amplified coherent laser beams 124, provision is made for a combination device 126 in particular; it is used to form the combined laser beam 104 by combining the amplified coherent laser beams 124.

For example, amplified coherent laser beams 124 output coupled from the gain device 120 are input coupled into the combination device 126.

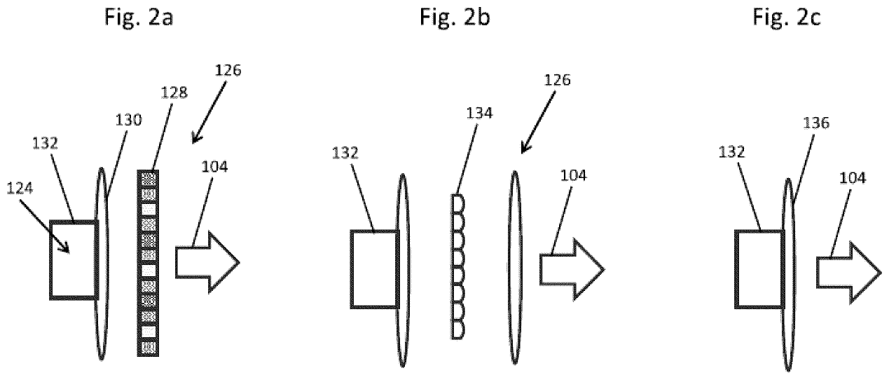

In an embodiment, the combination device 126 comprises a diffractive optical element 128 for combining the amplified coherent laser beams 124 (FIG. 2a). For example, a lens element 130 is provided for focusing the amplified coherent laser beams 124 on the diffractive optical element 128 (FIGS. 2a, 2b and 2c each indicate an envelope 132 of the amplified coherent laser beams 124 incident on the combination device 126 or on the lens element 130).

For example, the diffractive optical element 128 is or comprises a grating structure with a periodic pattern.

In respect of the technical details regarding the combination of coherent laser beams by means of diffractive optical elements, reference is made to the following scientific publications: “Coherent combination of ultrashort pulse beams using two diffractive optics”, Zhou et al., Opt. Lett. 42, 4422-4425 (2017) and “Diffractive-optics-based beam combination of a phase-locked fiber laser array”, Cheung et al., Opt. Lett. 33, 354-356 (2008).

In an alternative to that or in addition, provision can be made for the combination device 126 to comprise a microlens array 134 for combining the amplified coherent laser beams 124 (FIG. 2b).

In respect of the technical details regarding the combination of coherent laser beams by means of one or more microlens arrays, reference is made to WO 2020/016336 A1 and DE 10 2020 201 161 A1 by the same applicant.

In principle, it is also possible that the amplified coherent laser beams 124 are combined without a combination device 126. For example, the combined laser beam 104 is formed in that case by the superposition of the amplified coherent laser beams 124 in the far field.

In particular, a lens element 136 can then be provided for focusing the amplified coherent laser beams 124 (FIG. 2c).

For the purpose of measuring the respective phase difference &o between the amplified coherent laser beams 124, the apparatus 100 comprises a measuring device 138 which is arranged downstream of the gain device 120, for example in relation to a main propagation direction 140 of the coherent laser beams 102 and/or amplified coherent laser beams 124. In particular, the measuring device 138 is positioned between the gain device 120 and the combination device 126.

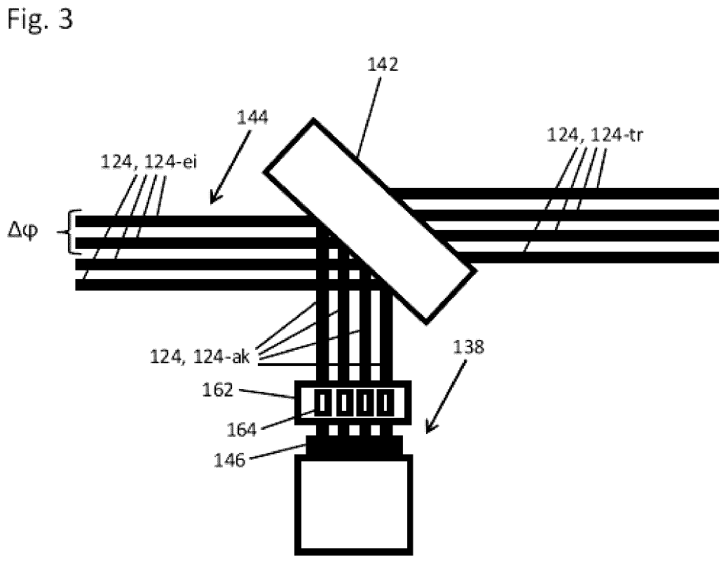

The various amplified coherent laser beams 124 in each case have a respective specific phase difference &₁₀₀ with respect to one another (indicated in FIG. 3), which is intended to be determined by means of the measuring device 138. The phase differences &o should be understood to mean actual phase difference values between the amplified coherent laser beams 124 and/or actual phase differences determined by means of the measuring device 138.

An output coupling device 142 can be provided in order to be able to supply the measuring device 138 with a component of the amplified coherent laser beams 124 (FIG. 3). This output coupling device 142 is, in respect of the main propagation direction 140, in particular arranged downstream of the gain device 120 and/or upstream of the combination device 126.

For example, the output coupling device 142 is arranged in a beam path 144 of the amplified coherent laser beams 124. The output coupling device 142 is used to output couple beam components of the amplified coherent laser beams 124 in order to input couple said beam components into the measuring device 138.

Amplified coherent laser beams 124-ei incident on the output coupling device 142 are split into output coupled amplified coherent laser beams 124-ak and transmitted amplified coherent laser beams 124-tr by means of the output coupling device 142.

The output coupled amplified coherent laser beams 124-ak each are beam components of the amplified coherent laser beams 124. Components of the amplified coherent laser beams 124 are therefore fed to the measuring device 138 by means of the output coupling device 142.

In particular, a power and/or an intensity of the output coupled amplified coherent laser beams 124-ak is less than 10% and in particular less than 5% of a power or intensity of the incident amplified coherent laser beams 124-ei.

The measuring device 138 comprises an input 146 for input coupling the beam components of the amplified coherent laser beams 124 into the measuring device 138. In particular, the respective beam components of the amplified coherent laser beams are input coupled into the measuring device 138 separately and/or with spatial separation.

The measuring device 138 comprises one or more measuring units 148. For example, the measuring device comprises N or N-1 measuring units in the case of N amplified coherent laser beams 124.

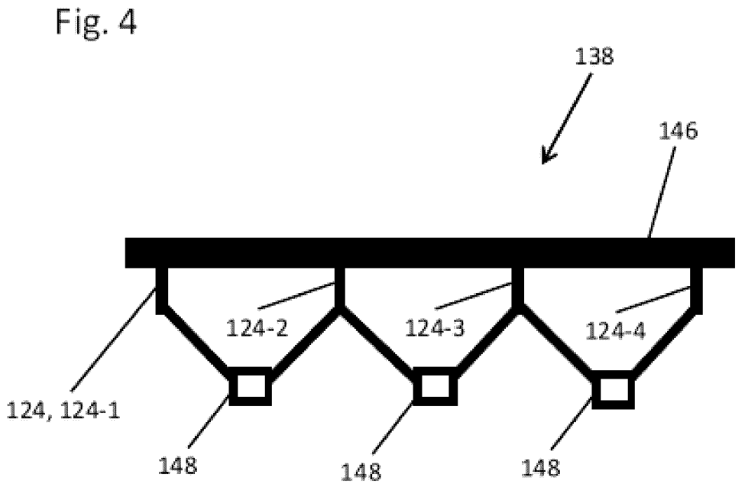

In the example shown in FIGS. 3 and 4, provision is made of four amplified coherent laser beams 124, the beam components of which are each input coupled into the measuring device 138. For example, these four amplified coherent laser beams are denoted by 124-1, 124-2, 124-3 and 124-4 hereinbelow.

The measuring units 148 in each case are used to measure pairwise phase differences &o between the various amplified coherent laser beams 124, with the phase differences &q being determining in each case for different pairs and/or combinations of two of the amplified coherent laser beams 124.

In principle, it is also possible for the measuring device 138 and/or the measuring units 148 in the measuring device 138 to be used to measure respective pairwise phase differences &₁₀₀ between one of the amplified coherent laser beams 124 and a reference laser beam 149.

For example, the reference laser beam 149 can be a laser beam output coupled from the laser source 106 and/or a beam component of the input laser beam 108. It is also possible that the reference laser beam 149 is one of the coherent laser beams 102 output coupled from the splitting device 110 (both variants are indicated in FIG. 1 by the dotted line).

Provision can be made for the reference laser beam 149 to be assigned a phase setting element 114 and/or a gain element 122.

In a variant, the reference laser beam 149 is input coupled into the measuring device 138 by means of the output coupling device 142, with then in particular a component of at least 90% and/or at least approximately 100% of the reference laser beam 149 being input coupled into the measuring device 138 (indicated in FIG. 1).

Depending on the embodiment, the amplified coherent laser beam denoted by 124-1 in FIG. 4 may correspond to the reference beam 149, for example.

In principle, it is also possible that the reference laser beam 149 is input coupled into the measuring device 138 by means of a separate beam path (not shown here) which, in particular, does not lead through the output coupling device 142.

In the exemplary embodiment according to FIG. 4, a phase difference &p between the amplified coherent laser beams 124-1 and 124-2, 124-2 and 124-3 and also 124-3 and 124-4 is measured in each case, with the phase difference &p between the different pairs of two amplified coherent laser beams 124 being measured in each case by means of a different measuring unit 148.

In the example shown in FIG. 4, the phase difference &p is consequently measured in each case for three different combinations, each consisting of two of the amplified coherent laser beams 124-1, 124-2, 124-3, 124-4. Consequently, a respective phase difference &p is measured between a first of the amplified coherent laser beams 124-1, 124-2, 124-3, 124-4 and exactly one further one of the amplified coherent laser beams 124-1, 124-2, 124-3, 124-4, with the first and the exactly one further one of the amplified current laser beams 124-1, 124-2, 124-3, 124-4 respectively being different in all measurements.

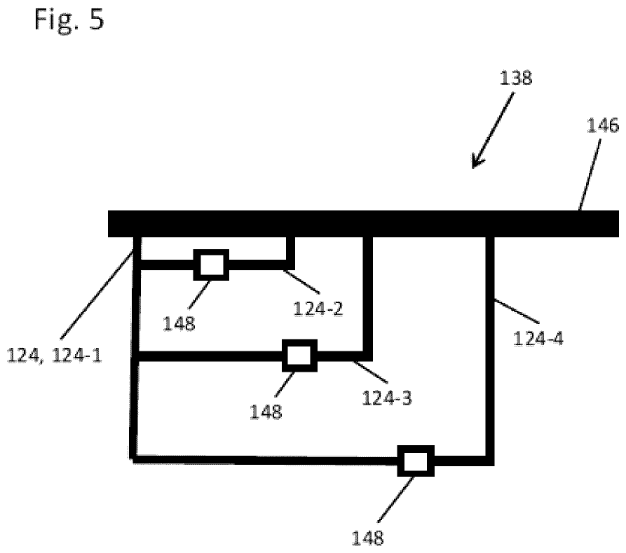

FIG. 5 shows a further embodiment of a measuring device 138. In this example, a respective phase difference &p between the amplified coherent laser beams 124-1 and 124-2 or 124-1 and 124-3 or 124-1 and 124-4 is measured by means of the different measuring units 148.

In the example shown in FIG. 5, the phase difference &p is consequently measured in each case for three different combinations, each consisting of two of the amplified coherent laser beams 124-1, 124-2, 124-3, 124-4. Consequently, a respective phase difference &p is measured between a first of the amplified coherent laser beams 124-1, 124-2, 124-3, 124-4 and exactly one further one of the amplified coherent laser beams 124-1, 124-2, 124-3, 124-4, with the first of the amplified current laser beams 124-1, 124-2, 124-3, 124-4 respectively being different in all measurements and the exactly one further one being the same in all measurements (specifically the amplified coherent laser beam 124-1 in the example shown).

In a variant of the example shown in FIG. 5, the amplified coherent laser beam 124-1 can correspond to the reference beam 149.

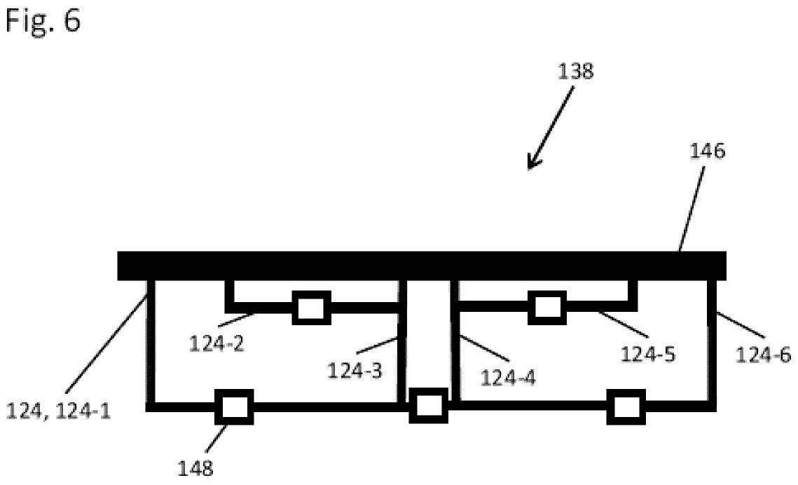

Six amplified coherent laser beams 124-1, 124-2, 124-3, 124-4, 124-5 and 124-6 are present in the example according to FIG. 6. In this example, the phase difference &φ is measured in each case for five different combinations consisting of in each case two of the amplified coherent laser beams. A phase difference &φ is measured in each case between a first of the amplified coherent laser beams and exactly one further one of the amplified coherent laser beams, with the first of the amplified coherent laser beams being different in all measurements and the exactly one further one of the amplified coherent laser beams being the amplified coherent laser beam 124-3 in three of the measurements (measurements between the amplified coherent laser beams 124-1 and 124-3, 124-2 and 124-3, 124-4, 124-3) and the amplified coherent laser beam 124-4 in two of the measurements (measurements between the amplified coherent laser beams 124-6 and 124-4, 124-5 and 124-6).

Beam guidance within the measuring device 138 can be free beam-based and/or fiber-based and/or waveguide-based, for example.

In a preferred embodiment, the measuring device 138 is embodied as a photonic integrated circuit (PIC), at least in portions. In this case—in a manner comparable to integrated circuits—optical components and/or beam guiding components are arranged on a substrate, for example a silicon substrate, a silicon nitride substrate and/or a lithium-niobate-on-insulator substrate.

In respect of the realization and properties of optical components and/or beam guiding components as a PIC, reference is made to the following scientific publication: “Direct and Sensitive Phase Readout for Integrated Waveguide.

Sensors”, by R. Halir et al., IEEE Photonics Journal, Volume 5, Number 4, August 2013, DOI: 10.1109/JPHOT.2013.2276747.

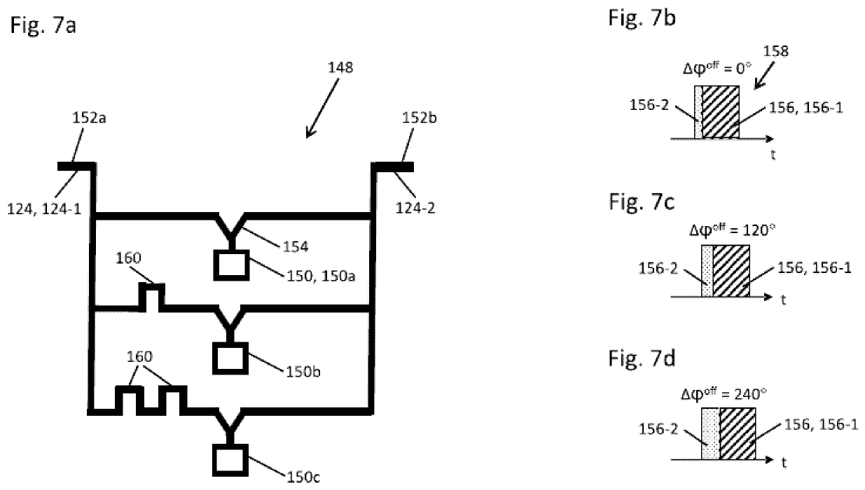

An exemplary embodiment of the measuring unit 148 is shown in FIG. 7. The measuring unit 148 comprises one or more measuring elements 150. Three measuring elements 150a, 150b, 150c are provided in the example shown.

The measuring element 150 is designed for time-resolved measurement of an intensity of a laser beam incident thereon or an intensity of a superposition of laser beams incident thereon. For example, the measuring element 150 is or comprises a photodiode.

The measuring unit 148 comprises a first input 152a for input coupling a first amplified coherent laser beam 124, for example the amplified coherent laser beam 124-1, and a second input 152b for input coupling a second amplified coherent laser beam 124, for example the amplified coherent laser beam 124-2.

The two amplified coherent laser beams 124-1 and 124-2 input coupled via the first input 152a and the second input 152b are superimposed and, in particular, superimposed collinearly at the measuring element 150.

A superposition element 154 is assigned to the measuring element 150 for the superposition of the two amplified coherent laser beams 124-1 and 124-2. For example, the superposition element 154 is embodied as a Y-coupler and in particular embodied as a fiber-based Y-coupler. For example, the superposition element 154 can be embodied as a multimode interference coupler (MMI coupler).

The two amplified coherent laser beams 124-1 and 124-2 are spatially split among the various measuring elements 150 of the measuring unit 148. In the example according to FIG. 7, the amplified coherent laser beams 124-1 and 124-2 are split among the three measuring elements 150a, 150b, 150c. To split the two amplified coherent laser beams 124-1 and 124-2 among the various measuring elements 150, provision is made of different beam paths for example.

The measuring device 138 and/or the measuring unit 148 are designed such that at least three different measurement values are determined by means of each measuring unit 148 for the amplified coherent laser beams 124 input coupled therein, with the different measurement values each being assigned a different offset phase difference Δp^{off}.

If the amplified coherent laser beams 124 are pulsed laser beams, then the amplified coherent laser beams 124 each have laser pulses 156. The offset phase difference Δp^{off} is then accompanied by a time offset, with which the respective laser pulses 156 of the two amplified coherent laser beams 124 are incident on the measuring element 150 (FIGS. 7b, 7c and 7d).

In the example shown in FIG. 7a, a respective measurement value for a pair 158 of a first laser pulse 156 and a further laser pulse 156 is recorded at one of the measuring elements 150, with in particular the respective offset phase differences Δp^{off} being different at the various measuring elements 150 of the measuring unit 148. The first laser pulse 156 and the further laser pulse 156 are assigned to different ones of the two coherent amplified coherent laser beams 124 which are input coupled into the measuring unit 148 and/or into the measuring element 150.

In particular, the pair 158 should be understood to mean a spatial superposition of the first and the further laser pulse 156 at the measuring element 150, with these laser pulses 156 having a defined offset phase difference Δp^{off} at the measuring element 150.

In FIGS. 7b, 7c and 7d, the laser pulses assigned to the amplified coherent laser beam 124-1 are denoted by 156-1, and the laser pulses assigned to the amplified coherent laser beam 124-2 are denoted by 156-2. FIG. 7b schematically shows the time offset of the laser pulses 156-1 and 156-2 incident on the measuring element 150a, FIG. 7c shows the time offset of the laser pulses 156-1 and 156-2 incident on the measuring element 150b, and FIG. 7d shows the time offset of the laser pulses 156-1 and 156-2 incident on the measuring element 150c.

Retardation elements 160 may be provided for the purpose of forming different offset phase differences Δp^{off} between the laser pulses 156-1 and 156-2 at the various measuring elements 150, wherein one or more retardation elements 160 may be assigned to one or more of the measuring elements 150 in each case.

For example, the retardation element 160 is designed to create a path length difference which for example results in a time offset and/or an offset phase difference Δp^{off} between the laser pulses 156 in the pair 158.

In the example according to FIG. 7a, a respective retardation element 160 is for example embodied to form an offset phase difference Δp^{off} of 120°.

In the example shown, no retardation element 160 is assigned to the amplified coherent laser beam 124-2 input coupled into the measuring elements 150a, 150b and 150c.

Further, no retardation element 160 is assigned to the measuring element 150a and/or the amplified coherent laser beam 124-1 input coupled into the measuring element 150a. For example, this results in an offset phase difference Δp^{off} of 0° between the two laser pulses 156-1 and 156-2 at the measuring element 150a.

A single retardation element 160 is assigned to the measuring element 150b and/or the amplified coherent laser beam 124-1 input coupled into the measuring element 150b. For example, this results in an offset phase difference Δp^{off} of 120° between the two laser pulses 156-1 and 156-2 at the measuring element 150b.

For example, two retardation elements 160 are assigned to the measuring element 150c and/or the amplified coherent laser beam 124-1 input coupled into the measuring element 150c. For example, this results in an offset phase difference &p^{off} of 240° between the two laser pulses 156-1 and 156-2 at the measuring element 150b.

Measurement values are captured at different offset phase differences &p^{off} for the two amplified coherent laser beams 124 assigned to the measuring unit 148 on account of the plurality of measurements performed by means of the measuring unit 148. These measurement values can be used to determine the actual phase difference &p between these two amplified coherent laser beams 124.

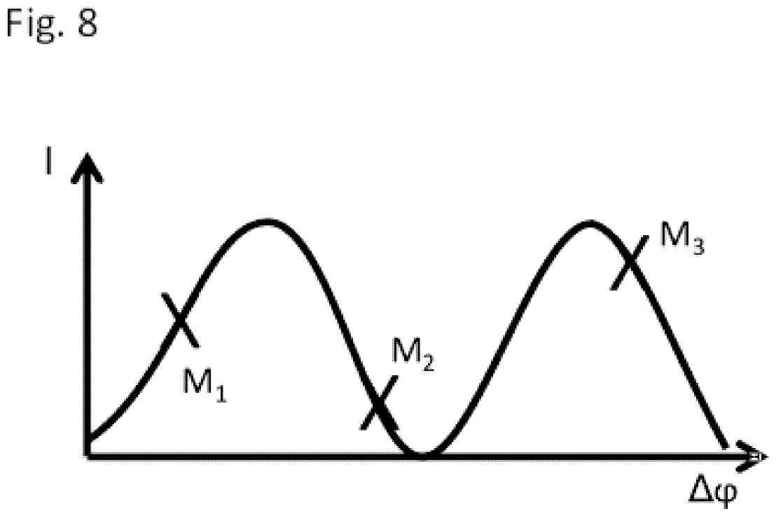

The measuring elements 150 of the measuring unit 148 are used to measure in each case intensities I of a superposition of the laser pulses 156-1, 156-2 associated with the pair 158, with the measured intensity I depending on the offset phase difference &p^{off} (FIG. 8). In particular, a respective measuring element 150 is used to measure a time-averaged intensity I of the laser pulses 156 in the pair 158 incident on the measuring element 150.

FIG. 8 shows an example of an intensity I measured at a measuring element 150 as a function of the phase difference &p. Three different measurement values M₁, M₂, M₃ are indicated in the example shown in FIG. 8, with for example the measurement value M₁ corresponding to the measuring element 150a and FIG. 7b (&p^{off}=0°), the measurement value M₂ corresponding to the measuring element 150b and FIG. 7c (&p^{off}=120°), and the measurement value M₃ corresponding to the measuring element 150c and FIG. 7d (&p^{off}=240°).

Measurement values for different offset phase differences &p^{off} are captured by means of different measuring elements 150 in the exemplary embodiment according to FIG. 7a, with for example a measuring element 150 being assigned in each case to a captured measurement value for a specific offset phase difference &p^{off}. In particular, in the example according to FIG. 7a, the various measuring elements 150 are used for a parallel measurement in time of pairs 158 of superimposed laser pulses 156 with different offset phase differences Δp^{off}.

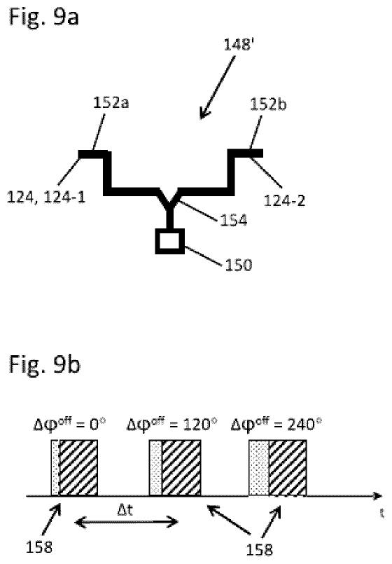

In an alternative to that, the embodiment of a measuring unit 148′ shown in FIG. 9a provides for measurements of pairs 158 of two laser pulses 156 to be performed for different offset phase differences Δp^{off} with a time offset. The embodiment of the measuring unit 148′ shown in FIG. 9a differs from the embodiment described above and shown in FIG. 7a in that a single measuring element 150 is provided. Otherwise, the measuring unit 148′ has the same structure as the measuring unit 148, and so reference is made to the description of the latter in this respect.

In this embodiment, provision is made for the pairs 158 with different offset phase differences Δp^{off} to be guided to the measuring element 150 in time-offset fashion, with the respective pairs 158 for example being incident on the measuring element 150 with a defined time offset Δt (FIG. 9b).

As a result, different measurement values M₁, M₂, M₃ are captured successively in time by means of the measuring element 150.

In this embodiment, the measuring device 138 is configured to provide the pairs 158 of two laser pulses 156 with a defined time offset Δt and respectively defined offset phase differences Δp^{off}.

If the amplified coherent laser beams 124 are pulsed laser beams, then the defined time offset Δt in a preferred embodiment corresponds at least approximately to a repetition rate of the pulsed laser beams.

For example, the repetition rate is in the range of 1 MHz to 1 GHz.

In particular, provision can be made for the phase setting device 112 to be controlled by means of the measuring device 138 in order to provide pairs 158 with a defined offset phase difference Δp^{off}. In particular, the measuring device 138 is configured to control the phase setting device 112 and/or signal-connected to the phase setting device 112.

In principle, it is also possible that the laser source 106 is controlled by means of the measuring device 138 in order to provide pairs 158 with a defined time offset Δt. To this end, the measuring device 138 is for example signal-connected to the laser source 106 and/or to a control device of the laser source 106.

As an alternative to that or in addition, a shutter device 162 controllable by means of the measuring device 138 can be provided for the purpose of creating the pairs 158 with a defined time offset Δt; this shutter device is arranged in the beam path of the coherent laser beams 102 and/or of the amplified coherent laser beams 124 (FIG. 3).

The shutter device 162 is configured to interrupt or clear a passage of amplified coherent laser beams 124 to the respective measuring units 148 of the measuring device 138. For example, the shutter device 162 comprises a plurality of shutter elements 164, with a shutter element in each case being assigned to one of the amplified coherent laser beams 124.

By suitably controlling the shutter device 162 using the measuring device 138, it is possible to supply laser pulses 156 and/or pairs 158 of laser pulses 156 of the respective amplified coherent laser beams 124 to a specific measuring element 150 with a defined time offset Δt. In particular, this may be provided whenever the amplified coherent laser beams are continuous wave laser beams.

For example, one or more of the shutter elements 164 may be arranged in the respective beam path of the amplified coherent laser beams 124 that are input coupled into the measuring device 138. In principle, it is also possible that shutter elements 164 are assigned to a measuring unit 148 and/or a measuring element 150 or part of a measuring unit 148 and/or measuring element 150.

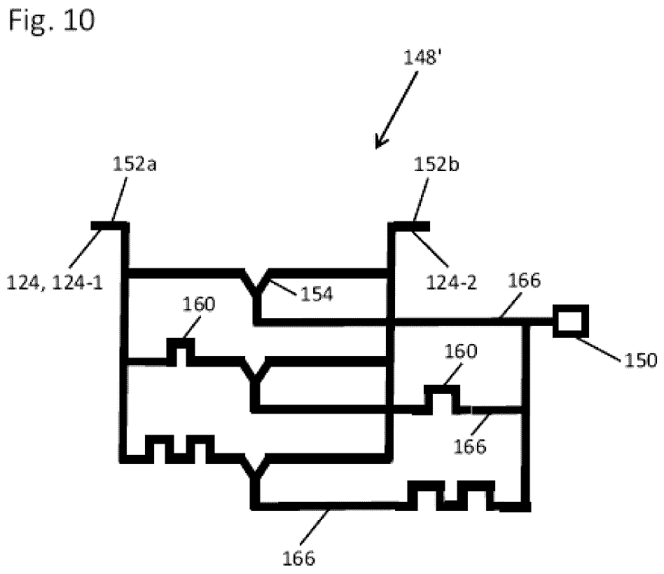

In principle, the pairs 158 of laser pulses 156 guided onto the measuring element 150 with a defined time offset Δt and a defined offset phase difference Δp^{off} can also be created by splitting the amplified coherent laser beams 124-1, 124-2 input coupled into the measuring unit 148′ among different beam paths 166 (FIG. 10). In particular, the different beam paths are each configured to create a pair 158 with a defined offset phase difference Δp^{off} and feed this pair to the measuring element 150 with a specific time offset Δt vis-à-vis a next or preceding pair 158. Retardation elements 160 arranged in the respective beam paths 166 may be provided to form the defined time offset Δt and the defined offset phase difference Δp^{off}.

By preference, one or more retardation elements 160 and/or one or more beam paths 166 may be realized as a PIC.

In the example shown in FIG. 10, three different beam paths 166 are provided for the purpose of providing the measuring element 150 with three pairs 158 with a defined time offset Δt and a defined offset phase difference Δp^{off}. A pair 158 is provided by means of each of the beam paths.

Provision can be made for the measuring device 138 to control the shutter device 162 for the purpose of performing a measurement, in order to supply pairs 158 of laser pulses 156 to the measuring units 148 and/or the measuring elements 150. In particular, the shutter device 162 is controlled such that the shutter elements 164 are open only for a duration required for the passage of a specific pair 158 of laser pulses 156 to the assigned measuring unit 148 and/or the assigned measuring element 150.

In particular, provision can be made for the measuring device 138 to be configured to supply the amplified coherent laser beams 124 to the respective measuring units 148 and/or measuring elements 150 at at least approximately the same intensity. To this end, provision can be made for the measuring device 138 to comprise gain elements.

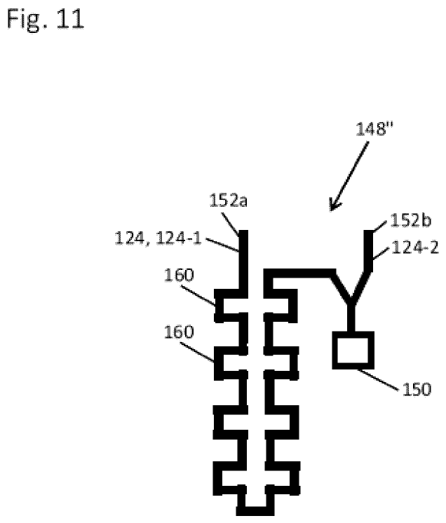

In an embodiment, provision can be made for the measuring device 138 to comprise at least one measuring unit 148″ having a measuring element 150, with provision being made for the two input coupled amplified coherent laser beams 124-1, 124-2 and/or the input coupled pair 158 of laser pulses 156 of these amplified coherent laser beams to have an offset phase difference &p^{off} of more than 2*pi (FIG. 11). For example, this can be realized by a multiplicity of retardation elements 160, which are assigned one of the two amplified coherent laser beams 124-1, 124-2 input coupled into the measuring unit 148″.

During operation of the apparatus 100, provision is made for the phase setting device 112 to be controlled in order to set the respective phase difference between the amplified coherent laser beams 124 to specified target phase difference values ^{&psoll}. Using the phase setting device 112, it is possible in the example shown to set the respective phase difference between the coherent laser beams 102 that are input coupled into the gain device 120, and this brings about a change in and/or setting of the respective phase difference between the assigned amplified coherent laser beams 124.

The apparatus comprises a control device 168 which controls the phase setting device 110 with specific control values on the basis of an assignment rule. The assignment rule contains an assignment of the control values to target phase difference values ^{&psoll} between the respective amplified coherent laser beams. For example, the assignment rule is or comprises an assignment table.

For example, an initial version of the assignment rule is determined by calibration measurements. In these calibration measurements, the phase setting device 112 is controlled with certain control values by the control device 168, for example, and the actual phase difference values &p arising for these control values are measured by means of the measuring device 138. As a result, relationships between the control values and the resultant phase difference values &p can be determined in order to define the assignment rule.

In particular, a memory device 170 can be provided, the latter being comprised by the control device 168 or assigned to the control device 168, with the assignment rule being stored in the memory device 170.

Deviations between the target phase difference values ^{&psoll} set on the basis of the assignment rule and the actual phase difference values &p of the amplified coherent laser beams 124 actually present by means of the measuring device 138 may arise during the operation of the apparatus 100.

Provision is made for the assignment rule to be optimized when the apparatus 100 is in operation, in order to minimize the deviation between the target phase difference values &pₛₒₗₗ and the actual phase difference values &p. An optimization unit 172 assigned to the control device 168 is provided for performing the optimization.

The optimization unit 172 adapts the assignment rule at least in part and/or modifies the latter at least in part in order to minimize the deviation between the target phase difference values ^{&}ₚₛₒₗₗ and the actual phase difference values &p, with in particular a comparison between the target phase difference values ^{&}ₚₛₒₗₗ and the actual phase difference values &p being implemented for minimization purposes.

For example, the optimization unit 172 is used at specific time intervals to update the assignment rule stored for controlling the phase setting device 112 by means of the control device 168, i.e., replace the assignment rule with a new assignment rule adapted as described above.

The control device 168, the measuring device 138, the memory device 170 and the optimization unit are in each case signal-connected with one another (indicated by the dashed line in FIG. 1).

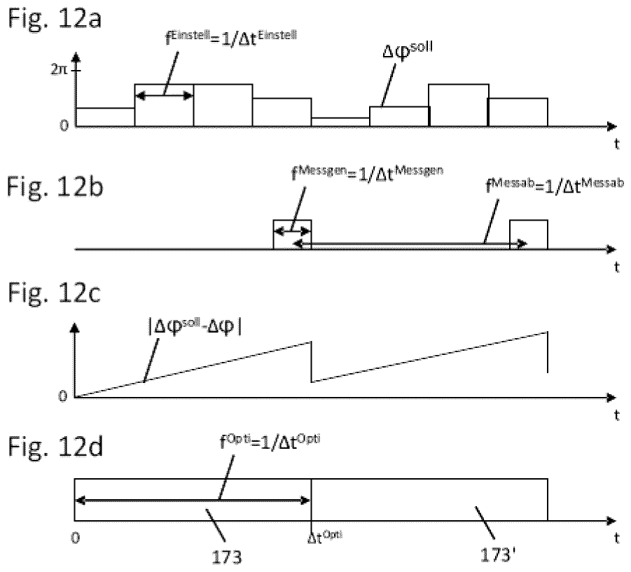

The phase setting device 112 is configured to set the respective phase difference between the coherent laser beams 102 and/or the amplified coherent laser beams 124 with a phase setting frequency f_{Einstell} to specified target phase difference values ^{&}_{φsoll} (for example, FIG. 12a shows a time curve of set target phase difference values &φₛₒₗₗ between two of the amplified coherent laser beams 124). This phase setting frequency ^{fEinstell} should be understood to mean a maximum frequency or a smallest time interval ^{&tEinstell=1/fEinstell} with which the respective phase difference is changeable or modified. The phase setting frequency ^{fEinstell} is also referred to as modulation frequency of the phase setting device.

In particular, the phase setting frequency ^{fEinstell} is in the range of 1 MHz to 50 MHz.

The measuring device 138 is configured to determine the respective phase difference &φ (actual phase difference) between the amplified coherent laser beams 124 with a measuring accuracy frequency ^{fMessgen} (FIG. 12b). This should be understood to mean a greatest frequency or a shortest time duration &t_{Messgen}=1/f_{Messgen} with which a phase difference can be resolved in time by the measuring device 138. The measuring accuracy frequency ^{fMessgen} is also referred to as measurement bandwidth.

In particular, the measuring accuracy frequency ^{fMessgen} is greater than or equal to the phase setting frequency f_{Einstell}.

The above-described measuring device 138 in particular enables measurements of the respective phase difference &φ with a measuring accuracy frequency ^{fMessgen} in the range of 1 MHz to 50 MHz.

Further, the measuring device 138 is configured to determine the respective phase difference &φ with a measuring interval frequency ^{fMessab} (FIG. 12b). This should be understood to mean a frequency or a time interval &t_{Messab}=1/f_{Messab} with which the respective phase difference between the amplified coherent laser beams 124 is determined or determinable by means of the measuring device 138.

In particular, the measuring interval frequency ^{fMessab} is in the range of 0.5 kHz to 5 kHz.

The optimization unit 172 is configured to optimize the assignment rule with an optimization frequency ^{fOpti}. This should be understood to mean a frequency or a time interval &t^{Opti}=1/f^{Opti} with which the stored assignment rule is adapted and/or updated by the optimization unit 172 in order to minimize the deviation between the target phase difference values ^{&}ₚₛₒₗₗ and the actual phase difference values &p (FIG. 12c).

In particular, the optimization frequency is in the range of 0.5 kHz to 5 kHz.

The optimization of the assignment rule with the optimization frequency ^{fOpti} is shown schematically in FIG. 12d. In the time interval 0<t<&t^{Opti}, the phase setting device 112 is controlled by the control device 168 on the basis of a first version 173 of the assignment rule. The assignment rule is replaced by an optimized version 173′ at the time t=&t_{Opti}, whereby the deviation between ^{&psoll} and &p is reduced at this time (cf. FIG. 12c).

Provision can be made for the apparatus 100 to comprise at least one additional measuring device 174, which is preferably disposed downstream of the measuring device 138 and/or downstream of the output coupling device 142 in relation to the main propagation direction 140. This additional measuring device 174 is designed to determine phase differences &p (actual phase differences) between the amplified coherent laser beams 124. Further, to transmit the determined phase differences &p to the control device 168, the additional measuring device 174 is signal-connected to the latter.

For example, the additional measuring device 174 can be arranged in a region of the combination device 126 and/or in a region of a workpiece (not shown here) to be processed by means of the at least one combined laser beam 104.

Further actual phase difference values &p, which can be taken into account when optimizing the assignment rule, can be determined by means of the additional measuring device 174. For example, for the purpose of optimizing the assignment rule, the optimization device 172 uses these actual phase difference values &p in addition to the actual phase difference values &p determined by the measuring device 138.

The measuring interval frequency ^{fMessab} and/or the measuring accuracy frequency f_{Messgen} of the additional measuring device 174 can correspond to those of the measuring device 138 or differ from those of the measuring device 138. In particular, the measuring accuracy frequency ^{fMessgen} of the additional measuring device 174 can be less than that of the measuring device 138.

Provision can be made for the apparatus 100 to comprise one or more sensor elements 176 which are configured to measure at least one parameter which influences the respective phase difference &p between the amplified coherent laser beams 124.

For example, sensor elements 176 can be assigned in each case to the phase setting device 112 and/or the gain device 120.

For example, the sensor elements 176 can be configured to measure temperature.

The sensor elements 176 are signal-connected to the control device 168 and/or to the optimization unit 172 for the purpose of transmitting the captured measurement values. The measurement values captured by means of the sensor elements 176 are taken into account by the optimization unit 172 when optimizing the assignment rule.

The apparatus 100 according to the invention operates as follows:

The input laser beam 108 is provided by means of the laser source 106 and input coupled into the splitting device 110. A plurality of coherent laser beams 102 are formed by splitting the input laser beam 108 by means of the splitting device 110. The coherent laser beams 102 are amplified by means of the gain device 120 and are output coupled as amplified coherent laser beams 124. Subsequently, one or more combined laser beams 104 are formed by combining the amplified coherent laser beams 124, with the combination being implemented by means of the combination device 126, for example.

To form the combined laser beams 104 with the desired properties, it is necessary to match the respective phase differences &φ of the amplified coherent laser beams 124 to one another and to subject these to open-loop and/or closed-loop control.

To set the respective phase differences &φ of the amplified coherent laser beams 124, the phase setting device 168 controls the phase setting device 110 with control values according to the assignment rule. As a result, the respective phase differences between the coherent laser beams 102 are set prior to their input coupling into the gain device 120, and this in turn brings about a setting of the respective phase differences &φ of the amplified coherent laser beams 124.

The actual phase differences &φ of the amplified coherent laser beams 124 are measured by means of the measuring device 138 and transmitted to the control device 168 and/or the optimization unit 172.

The optimization unit compares the set target phase difference values with the actually measured actual phase difference values &φ between the amplified coherent laser beams 124 and subsequently calculates an updated assignment rule such that a deviation between the target phase difference values and the actual phase difference values &φ is minimized.

For example, the assignment rule can be updated in a manner analogous to the calibration and linearization of nonlinear sensor curves on the basis of reference measurements. Corresponding methods can be adapted such that the calibration procedure is continually improved further on the basis of individual measurement values and, optionally, further sensor information is taken into account. For example, such methods are known from the following publications: “Lookup Table Optimization for Sensor Linearization in Small Embedded Systems”, L. E. Bengtsson, Journal of Sensor Technology, Vol. 2 No. 4, 2012, pp. 177-184, “A Linearisation and Compensation Method for Integrated Sensors,” P. Hille, R. Höhler and H. Strack, Sensors and Actuators A, Vol. 44, No. 2, 1994, pp. 95-102 and “Linearization of Analog-to-Digital Converters”, A. C. Dent and C. F. N. Cowan, IEEE Transactions on Circuits and Systems, Vol. 37, No. 6, 1990, pp. 729-737; reference is made thereto in the context of updating the assignment rule.

Provision can be made for the measurement values determined by means of the additional measuring device 174 and/or by means of the sensor elements 176 to be additionally used for the purpose of optimizing the assignment rule.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

I Intensity
M¹-M³ Measurement value
&φ Phase difference/actual phase difference value
&φₛₒₗₗ Target phase difference value
&φ^{off} Offset phase difference
&t Time offset
f_{Einstell} Phase setting frequency
f_{Messab} Measuring interval frequency
f_{Messgen} Measuring accuracy frequency
f_{Opti} Optimization frequency
100 Apparatus
102 Coherent laser beam
104 Combined laser beam
106 Laser source
108 Input laser beam
110 Splitting device
112 Phase setting device
114 Phase setting element
120 Gain device
122 Gain element
124 Amplified coherent laser beam
124-ei Incident amplified coherent laser beam
124-tr Transmitted amplified coherent laser beam
124-ak Output coupled amplified coherent laser beam
124-1 Amplified coherent laser beam
124-2 Amplified coherent laser beam
124-3 Amplified coherent laser beam
124-4 Amplified coherent laser beam
126 Combination device
128 Diffractive optical element
130 Lens element
132 Envelope
134 Microlens array
136 Lens element
138 Measuring device
140 Main propagation direction
142 Output coupling device
144 Beam path
146 Input
148 Measuring unit
148′ Measuring unit
149 Reference laser beam
150 Measuring element
150a Measuring element
150b Measuring element
150c Measuring element
152a First input
152b Second input
154 Superposition element
156 Laser pulse
156-1 Laser pulse
156-2 Laser pulse
158 Pair of two laser pulses
160 Retardation element
162 Shutter device
164 Shutter element
166 Beam path
168 Control device
170 Memory device
172 Optimization unit
173 First version of the assignment rule
173′ Optimized version of the assignment rule
174 Additional measuring device
176 Sensor element

1. An apparatus for combining coherent laser beams to form at least one combined laser beam, the apparatus comprising:
a phase setting device,
a gain device for amplifying the coherent laser beams to form amplified coherent laser beams, wherein the amplified coherent laser beams are output coupled from the gain device,
a control device for controlling the phase setting device based on a specified assignment rule in order to set a respective phase difference between the amplified coherent laser beams to specified target phase difference values,
a measuring device for determining a respective actual phase difference value between the amplified coherent laser beams, and
an optimization unit coupled to the control device and configured to optimize the assignment rule based on the actual phase difference values determined by the measuring device.

2. The apparatus as claimed in claim 1, wherein the assignment rule is updated at time intervals by the optimization unit, wherein the assignment rule is modified by the optimization unit such that a deviation between a respective target phase difference value set by the control device according to the assignment rule and a respective actual phase difference value measured by the measuring device is minimized.

3. The apparatus as claimed in claim 1, wherein the controlling of the phase setting device by the control device is implemented with a phase setting frequency, and wherein the assignment rule is updated with an optimization frequency, the phase setting frequency being greater than the optimization frequency.

4. The apparatus as claimed in claim 3, wherein the phase setting frequency is at least 1 MHz and/or at most 1 GHz.

5. The apparatus as claimed in claim 3, wherein the optimization frequency is at least 0.5 kHz and/or at most 500 kHz.

6. The apparatus as claimed in claim 3, wherein the actual phase difference values between the amplified coherent laser beams are determined by the measuring device with a measuring interval frequency, the phase setting frequency being greater than the measuring interval frequency.

7. The apparatus as claimed in claim 3, wherein the actual phase difference values between the amplified coherent laser beams are determined by the measuring device with a measuring accuracy frequency which is greater than or equal to the phase setting frequency.

8. The apparatus as claimed in claim 1, wherein the assignment rule comprises an assignment of control values used by the control device to control the phase setting device to the target phase difference values of the respective amplified coherent laser beams,
and/or wherein the assignment rule comprises an assignment table.

9. The apparatus as claimed in claim 1, further comprising at least one additional measuring device for determining the respective actual phase difference between the amplified coherent laser beams, wherein the at least one additional measuring device is arranged downstream of the measuring device in particular.

10. The apparatus as claimed in claim 1, further comprising at least one sensor element for measuring a parameter that influences the respective phase difference between the amplified coherent laser beams, wherein measurement values of the parameter measured by the at least one sensor element are transmitted to the control device and/or to the optimization unit.

11. A laser system comprising at least one laser source for providing coherent laser beams and an apparatus for combining the coherent laser beams as claimed in claim 1.

12. A method for combining coherent laser beams to form at least one combined laser beam, the method comprising:
setting a respective phase difference between the coherent laser beams by using a phase setting device,
amplifying the coherent laser beams to form amplified laser beams by using a gain device, wherein the amplified coherent laser beams being output coupled from the gain device,
controlling the phase setting device by using a control device based on a specified assignment rule in order to set the respective phase difference between the amplified coherent laser beams to a respective specified target phase difference value,
determining a respective actual phase difference value between the amplified coherent laser beams by using a measuring device, and
optimizing the assignment rule based on the actual phase difference values determined by the measuring device by using an optimization unit coupled to the control device.
